(19) United States
(12) Patent Application Publication
(10) Pub. No.: US 2026/0244892 A1
(43) Pub. Date: Aug. 20, 2026

(54) CONTACTLESS COMMUNICATION APPARATUS

(71) Applicant: KYOCERA DOCUMENT SOLUTIONS INC., OSAKA-SHI (JP)

(72) Inventor: TAKUYA HAMADA, OSAKA-SHI (JP)

(21) Appl. No.: 19/536,241

(22) Filed: Feb. 11, 2026

(30) Foreign Application Priority Data
Feb. 20, 2025 (JP) 2025-025941

(51) Int. Cl. G06K 19/077; H01Q 1/50; H01Q 7/00

(52) U.S. Cl. CPC G06K 19/07779; H01Q 1/50; H01Q 7/00

(57) ABSTRACT

A contactless communication apparatus includes a board, a semiconductor component, an antenna pattern, a first ground pattern, a second ground pattern, a first wiring portion, a second wiring portion, a third wiring portion, and a return path. The board includes a first surface and a second surface that is situated opposite to the first surface. The semiconductor component includes an output terminal and a ground terminal, and is provided on the first surface. The antenna pattern includes a start end that is an outer peripheral end, and a termination end that is an inner peripheral end. The antenna pattern is a coil-shaped pattern that is formed on the second surface. The first ground pattern is formed along a peripheral edge portion of the first surface. The second ground pattern is formed in an air-core portion of the antenna pattern formed on the second surface, and is connected to the first ground pattern. The first wiring portion connects the output terminal and the start end. The second wiring portion includes a capacitor and connects the first wiring portion and the first or second ground pattern. The third wiring portion connects the first or second ground pattern and the ground terminal. The return path passes through the first wiring portion, the second wiring portion, the first or second ground pattern, and the third wiring portion. The area of a portion surrounded by the path accounts for 25% or less of the area of the first surface.

### CROSS-REFERENCE TO RELATED PATENT APPLICATION

This application claims the benefit of Japanese Priority Patent Application JP 2025-025941 filed Feb. 20, 2025, the entire contents of which are incorporated herein by reference.

### FIELD OF THE DISCLOSURE

The present technology relates to a contactless communication apparatus that contactlessly communicates with another apparatus such as a reader/writer.

### BACKGROUND OF THE DISCLOSURE

In recent years, contactless wireless communication apparatuses that use a radio frequency identification (RFID) technology are included in, for example, transportation cards, electronic money cards, credit cards, and smartphones (for example, refer to Japanese Patent Application Laid-open No.2015-65649).

Typically, this type of contactless wireless communication apparatus includes, for example, a controller and a coil-shaped antenna pattern. The contactless wireless communication apparatus performs electromagnetic induction through the antenna pattern using output from another apparatus such as a reader/writer, and generates necessary electric power. Further, the controller performs a necessary process by use of the electric power to contactlessly wirelessly communicate with the other apparatus such as a reader/writer through the antenna pattern.

### SUMMARY OF THE DISCLOSURE

A contactless communication apparatus according to the present technology includes a board, a semiconductor component, an antenna pattern, a first ground pattern, a second ground pattern, a first wiring portion, a second wiring portion, a third wiring portion, and a return path. The board includes a first surface and a second surface that is situated opposite to the first surface. The semiconductor component includes an output terminal and a ground terminal, and is provided on the first surface. The antenna pattern includes a start end that is an outer peripheral end, and a termination end that is an inner peripheral end. The antenna pattern is a coil-shaped pattern that is formed on the second surface. The first ground pattern is formed along a peripheral edge portion of the first surface. The second ground pattern is formed in an air-core portion of the antenna pattern formed on the second surface, and is connected to the first ground pattern. The first wiring portion connects the output terminal and the start end. The second wiring portion includes a capacitor and connects the first wiring portion and the first or second ground pattern. The third wiring portion connects the first or second ground pattern and the ground terminal. The return path passes through the first wiring portion, the second wiring portion, the first or second ground pattern, and the third wiring portion. The area of a portion surrounded by the path accounts for 25% or less of the area of the first surface.

### BRIEF DESCRIPTION OF THE DRAWINGS

FIG. 1 is a plan view of a contactless communication apparatus according to a first embodiment of the present technology, as viewed from a front surface of the contactless communication apparatus.

FIG. 2 is a diagram used to describe basic ideas of the present technology.

FIG. 3 is a diagram used to describe the basic ideas of the present technology.

FIG. 4 illustrates a contactless communication apparatus according to a first comparative example.

FIG. 5 illustrates a result of measuring unnecessary radiation in the contactless communication apparatus according to the first comparative example.

FIG. 6 illustrates a result of measuring unnecessary radiation in the contactless communication apparatus according to the first embodiment of the present technology.

FIG. 7 is a plan view of a contactless communication apparatus according to a second embodiment of the present technology, as viewed from a front surface of the contactless communication apparatus.

FIG. 8 illustrates a contactless communication apparatus according to a second comparative example.

FIG. 9 is a plan view of a contactless communication apparatus according to a third embodiment of the present technology, as viewed from a front surface of the contactless communication apparatus.

### DETAILED DESCRIPTION OF THE EXEMPLARY EMBODIMENTS

There is an increase in unnecessary radiation in the contactless wireless communication apparatus. Thus, the present technology provides a contactless communication apparatus that makes it possible to reduce unnecessary radiation.

Hereinafter, embodiments of the present technology will be described with reference to the drawings.

### First Embodiment

### Overall Configuration and Configuration of Each Structural Element

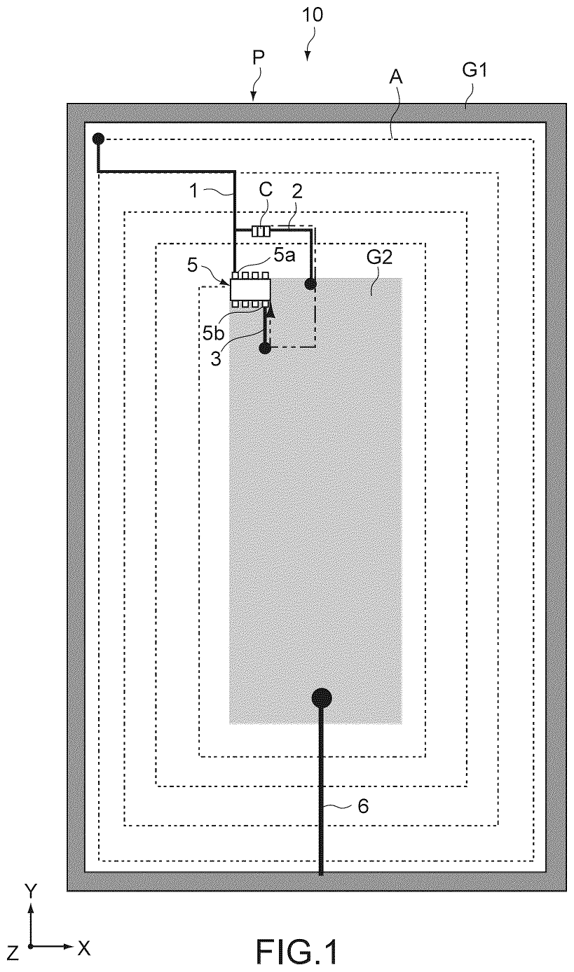

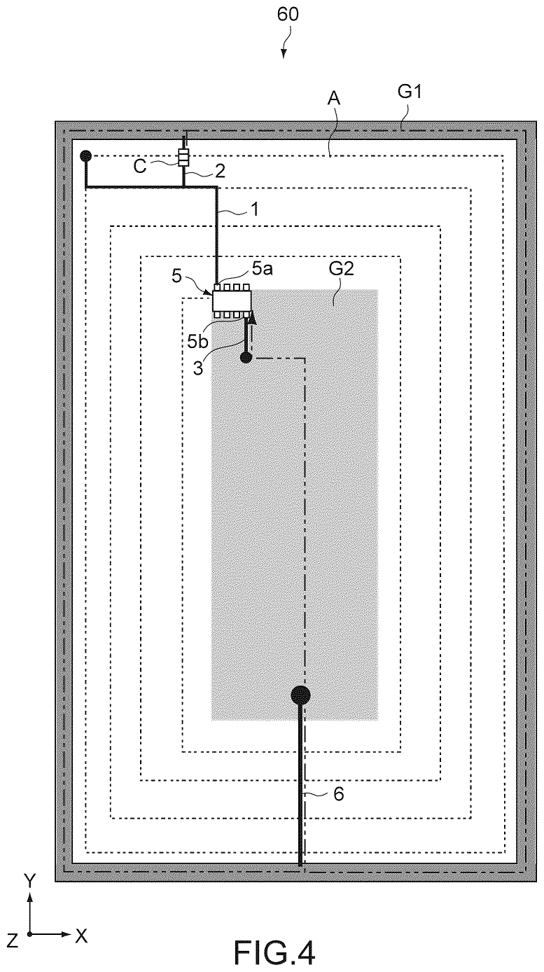

FIG. 1 is a plan view of a contactless communication apparatus 10 according to a first embodiment of the present technology, as viewed from a front surface of the contactless communication apparatus 10. Note that, in FIG. 1, each component arranged on a back surface of the contactless communication apparatus 10 is also shown transparently (the same applies to FIGS. 4 and 7 to 9 described later).

The contactless communication apparatus 10 is a contactless wireless communication apparatus that interactively contactlessly communicates with another apparatus such as a reader/writer in, for example, a 13.56-MHz frequency band using RFID techniques. The contactless communication apparatus 10 is included in, for example, a transportation card, an electronic money card, a credit card, or a smartphone, and may be included in any apparatus when being used for the purpose of contactlessly communicating with another apparatus.

As illustrated in FIG. 1, the contactless communication apparatus 10 includes a thin-plate board P (a printed-circuit board P) that has a rectangular shape in the plan view. Note that, in the example illustrated in FIG. 1, the board P has a rectangular shape in the plan view, but may have a shape other than the rectangular shape, such as a polygonal shape or a circular shape. The board P may have any shape. The board P includes a front surface (a first surface) and a back surface (a second surface) that is situated opposite to the front surface.

### Configuration of Back Surface

Note that, from between configurations of the front surface and the back surface in the board P, the configuration of the back surface is first described in the present embodiment (shown transparently in FIG. 1).

The contactless communication apparatus 10 includes, on its back surface, a coil-shaped antenna pattern A, and a plain second ground pattern G2 arranged in a center portion of the board P.

The antenna pattern A includes two functions including serving as an antenna for communication and serving as a power generating source that generates power by use of electromagnetic induction. The antenna pattern A is formed spirally, where the spiral has a diameter gradually made smaller from an outer periphery to an inner periphery of the antenna pattern A.

The antenna pattern A includes a start end at a position corresponding to one of four corner portions on an outer periphery of the board P (an upper-left corner portion in FIG. 1), and a termination end on an inner periphery of the board P. Further, in a center portion of the antenna pattern A, there is an air-core portion in which there does not exist the antenna pattern A.

The second ground pattern G2 is situated in the air-core portion of the antenna pattern A and electrically connected to the termination end of the antenna pattern A. In the example illustrated in FIG. 1, the second ground pattern G2 has a rectangular shape in the plan view. Note that the second ground pattern G2 may have a shape other than a rectangular shape, such as a polygonal shape or a circular shape. The second ground pattern G2 may have any shape.

### Configuration of Front Surface

Next, the configuration of the front surface of the board P is described. The contactless communication apparatus 10 includes, on its front surface, a strip-shaped first ground pattern G1 that is formed along an outer peripheral edge of the board P. Further, on its front surface, the contactless communication apparatus 10 includes, for example, various electronic components included in a controller of the contactless communication apparatus 10, and various pieces of wiring necessary for the electronic components.

The first ground pattern G1 is in the form of a strip having a small width, and is provided on the front surface of the board P to extend along and around the outer peripheral edge of the board P. The first ground pattern G1 is electrically connected to the second ground pattern G2 through a ground connecting wiring portion 6.

The ground connecting wiring portion 6 is formed on the front surface of the board P, and connects the first ground pattern G1 and the second ground pattern G2. Specifically, one of ends of the ground connecting wiring portion 6 is connected to the first ground pattern G1, and another of the ends is connected to the second ground pattern G2 through a hole (such as a via) that passes through the board P vertically.

The various electronic components included in the controller of the contactless communication apparatus 10, and the necessary wiring are arranged in a region surrounded by the first ground pattern G1. In the example illustrated in FIG. 1, only electronic components and wiring, from among the various electronic components included in the controller and the necessary wiring, that are necessary to describe the present technology are shown, and illustrations of a portion other than the necessary electronic components and wiring are omitted. In other words, in addition to the illustrated electronic component and wiring, a large number of electronic components and pieces of wiring are actually provided on the front surface of the board P.

An integrated circuit (IC) chip 5 for communication (a semiconductor component) is provided on the front surface of the board P as the electronic component included in the controller. The IC chip 5 performs a process necessary to communicate with another apparatus such as a reader/writer, and contactlessly communicates with the other apparatus through the antenna pattern A.

The IC chip 5 includes a plurality of terminals including an output terminal 5a used to output a signal for communication (an output waveform), and a ground terminal 5b connected to ground.

One of ends of a first wiring portion 1 is connected to the output terminal 5a of the IC chip 5. The first wiring portion 1 is provided on the front surface of the board P, and connects the output terminal 5a of the IC chip 5 and the start end of the antenna pattern A. Specifically, the one of the ends of the first wiring portion 1 is connected to the output terminal 5a of the IC chip 5, and another of the ends is connected to the start end of the antenna pattern A through a hole (such as a via) that passes through the board P vertically.

A second wiring portion 2 is connected to the first wiring portion 1 so that the second wiring portion 2 appears to branch off from the first wiring portion 1. The second wiring portion 2 is provided on the front surface of the board P, and connects the first wiring portion 1 and the second ground pattern G2 (one of the first ground pattern G1 and the second ground pattern G2 that is connected to the ground terminal 5b of the IC chip 5 through a third wiring portion 3). Specifically, one of ends of the second wiring portion 2 is connected to a middle portion of the first wiring portion 1, and another of the ends is connected to the second ground pattern G2 through a hole (such as a via) that passes through the board P vertically.

A capacitor C is provided to the second wiring portion 2. The capacitor C is used to cut an excessive high-frequency component out of a signal output via the output terminal 5a of the IC chip 5.

Further, one of ends of the third wiring portion 3 is connected to the ground terminal 5b of the IC chip 5. The third wiring portion 3 is provided on the front surface of the board P, and connects the ground terminal 5b of the IC chip 5 and the second ground pattern G2. Specifically, the one of the ends of the third wiring portion 3 is connected to the ground terminal 5b of the IC chip 5, and another of the ends is connected to the second ground pattern G2 through a hole (such as a via) that passes through the board P vertically.

Here, in the present embodiment, a portion of output (current) via the output terminal 5a of the IC chip 5 returns to the ground terminal 5b of the IC chip 5 through, for example, the respective wiring portions. This results in forming a return path. Specifically, the return path in the first embodiment is a path that passes through a portion of the first wiring portion 1 (from a point of connection with the IC chip 5 to a point of connection with the second wiring portion 2), the second wiring portion 2, a portion within the second ground pattern G2 (refer to a dash-dot-dot line), and the third wiring portion 3.

Here, FIG. 1 illustrates a region downstream of the capacitor C in the return path using the dash-dot-dot line. An excessive high-frequency component is generated in the region situated downstream of the capacitor C and indicated by the dash-dot-dot line. This may be a cause of unnecessary radiation.

However, the present embodiment provides a configuration of the return path that enables the return path to be made as short as possible. Typically, the area of a portion surrounded by the return path accounts for 25% or less of the area of the front surface (or the back surface) of the board P (or the area of a portion surrounded by the first ground pattern G1). Alternatively, the area of the portion surrounded by the return path accounts for, for example, 20% or less, 15% or less, 10% or less, 5% or less, 4% or less, or 3% or less of the area of the front surface (or the back surface) of the board P.

Note that an effect of reducing unnecessary radiation is greater if a proportion of the area of the portion surrounded by the return path in the area of the front surface of the board P (or the area of the portion surrounded by the first ground pattern G1) is smaller. However, there are limitations in making the proportion smaller, considering arrangements of, for example, the ground patterns G1 and G2, the IC chip 5, and the wiring portions 1 to 3.

### Basic Ideas, Effects, and Others of Present Technology

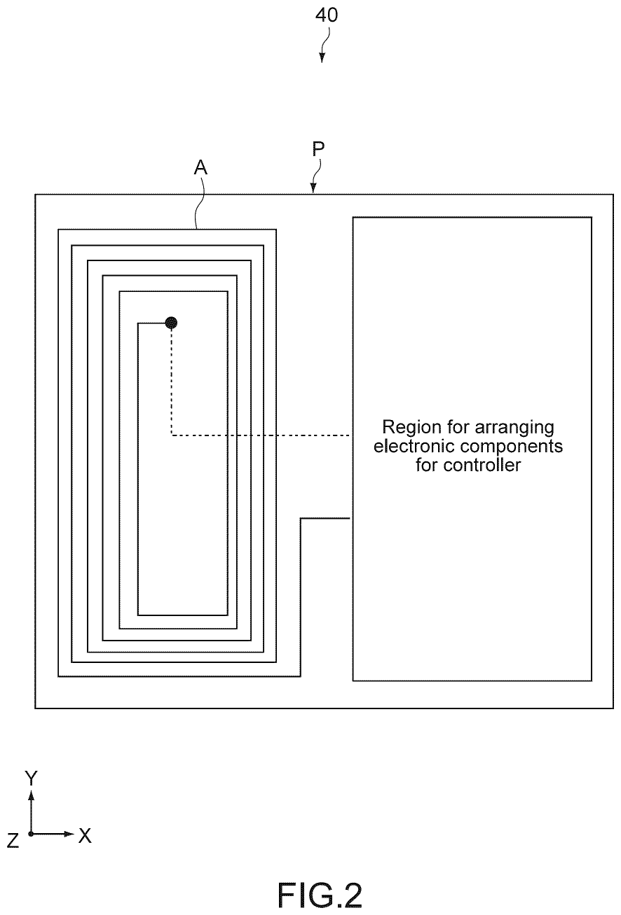

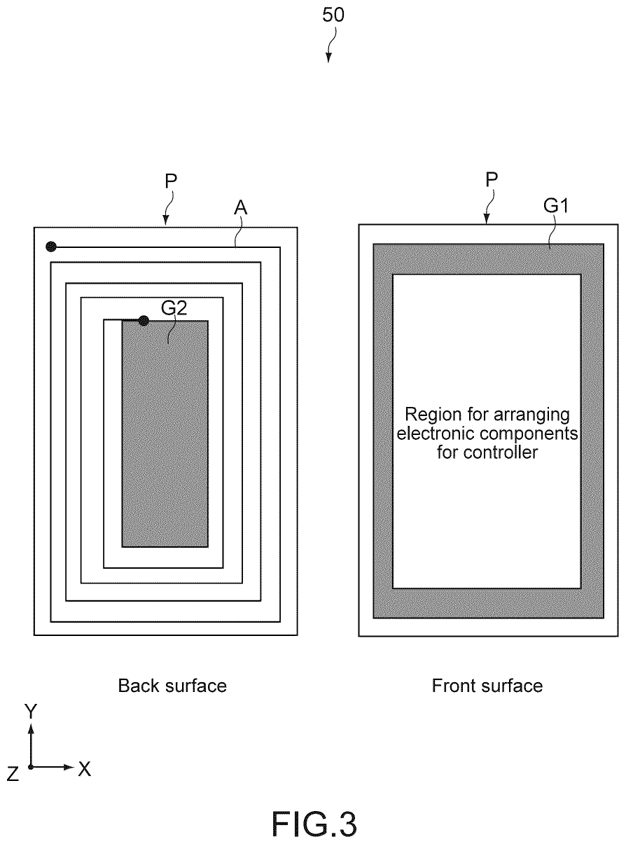

Next, basic ideas of the present technology are described, and effects and others of the present technology are also described. FIGS. 2 and 3 are diagrams used to describe the basic ideas of the present technology.

Here, the antenna pattern A is typically arranged separately from the various electronic components included in the controller and the wiring portions, in order to stabilize antenna characteristics. Further, a power supply and a plain ground pattern are not arranged on a back side of the antenna pattern A, in order to prevent a stray capacitance of the antenna from being increased.

Thus, a contactless communication apparatus 40 illustrated in FIG. 2 is configured such that, on one of the surfaces of the board P, the antenna pattern A is arranged separately from the electronic components for the controller and the wiring portions. However, the configuration illustrated in FIG. 2 results in a larger size.

In a contactless communication apparatus 50 illustrated in FIG. 3, the antenna pattern A is arranged on the back surface of the board P, whereas the electronic components for the controller and the wiring portions are arranged on the front surface of the board P, in order to solve the issue about the size. In this case, the plain ground pattern G2 is arranged in the air-core portion situated in the center portion of the antenna pattern A, and the strip-shaped ground pattern G1 (in the form of one full 360-degree loop in the example illustrated in FIG. 3, but there is no need to form a loop) is arranged around a region for arranging the electronic components for the controller and the wiring portions. This also makes it possible to deal with the issue about stray capacitance.

Note that the contactless communication apparatus 10 according to the present embodiment can also solve the issue about stray capacitance (the plain ground pattern G2 and the like are not arranged on the back side of the antenna pattern A) and the issue about the size (the antenna pattern A and the controller are arranged separately on the back surface and the front surface), as in the case of the contactless communication apparatus 50 illustrated in FIG. 3.

On the other hand, there is an issue about unnecessary radiation in wireless communication. The issue about unnecessary radiation is described with reference to a contactless communication apparatus 60 according to a first comparative example. FIG. 4 illustrates the contactless communication apparatus 60 according to the first comparative example.

The contactless communication apparatus 60 according to the first comparative example is different from the contactless communication apparatus 10 according to the first embodiment in the configuration of the second wiring portion 2. In regard to the other points, the contactless communication apparatus 60 basically has a configuration similar to the configuration of the contactless communication apparatus 10.

In the first comparative example, one of the ends of the second wiring portion 2 is connected to a middle portion of the first wiring portion 1, and another of the ends is connected to the first ground pattern G1, as illustrated in FIG. 4 (in the first embodiment, the other of the ends is connected to the second ground pattern G2).

Further, in the first comparative example, there are two return paths that are a first return path and a second return path.

The first return path is a path that passes through a portion of the first wiring portion 1 (from a point of connection with the IC chip 5 to a point of connection with the second wiring portion 2), the second wiring portion 2, a right portion of the first ground pattern G1 (a path passing clockwise from the point of connection with the second wiring portion 2 to a point of connection with the ground connecting wiring portion 6), the ground connecting wiring portion 6, a portion within the second ground pattern G2 (refer to a dash-dot-dot line), and the third wiring portion 3.

On the other hand, the second return path is a path that passes through the portion of the first wiring portion 1 (from the point of connection with the IC chip 5 to the point of connection with the second wiring portion 2), the second wiring portion 2, a left portion of the first ground pattern G1 (a path passing counterclockwise from the point of connection with the second wiring portion 2 to the point of connection with the ground connecting wiring portion 6), the ground connecting wiring portion 6, the portion within the second ground pattern G2 (refer to the dash-dot-dot line), and the third wiring portion 3.

Here, FIG. 4 illustrates a region downstream of the capacitor C in the first and second return paths using the dash-dot-dot line. An excessive high-frequency component is generated in the region situated downstream of the capacitor C and indicated by the dash-dot-dot line. This may be a cause of unnecessary radiation. This results in not satisfying the requirement of the radio standards.

In the first comparative example, the return paths are long, and this results in a greater unnecessary radiation. Thus, the present embodiment provides a configuration of the return path that enables the return path to be made as short as possible.

Here, in the first comparative example, the area of a portion surrounded by the first return path accounts for about 50% of the area of the front surface of the board P. Further, the area of a portion surrounded by the second return path accounts for about 50% of the area of the front surface of the board P. Thus, a total of the area of the portion surrounded by the first return path and the area of the portion surrounded by the second return path accounts for about 100% of the area of the front surface of the board P.

On the other hand, in the present embodiment, the area of the portion surrounded by the return path accounts for, for example, 25% or less, 20% or less, 15% or less, 10% or less, 5% or less, 4% or less, or 3% or less of the area of the front surface (or the back surface) of the board P. This results in making the return path shorter and thus in being able to reduce an excessive high-frequency component. This makes it possible to reduce unnecessary radiation.

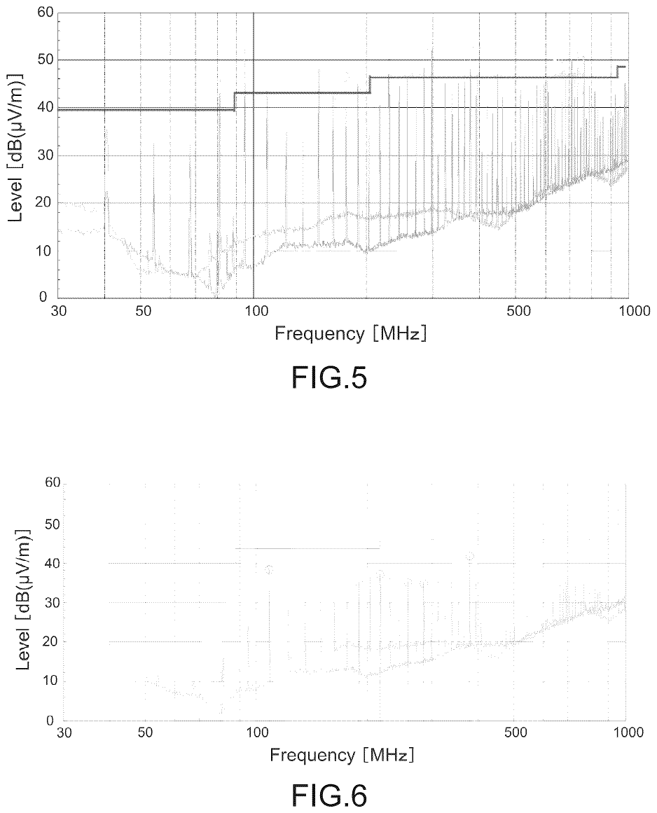

FIG. 5 illustrates a result of measuring unnecessary radiation in the contactless communication apparatus 60 according to the first comparative example. FIG. 6 illustrates a result of measuring unnecessary radiation in the contactless communication apparatus 10 according to the first embodiment of the present technology.

In FIGS. 5 and 6, a horizontal axis represents a frequency [MHz] of unnecessary radiation, and a vertical axis represents a noise level [dB(μV/m)] in the unnecessary radiation. As can be appreciated from comparison between FIGS. 5 and 6, the noise level in unnecessary radiation in the contactless communication apparatus 10 according to the first embodiment in FIG. 6 is lower in all of the frequency domain, compared to the case of the contactless communication apparatus 60 according to the first comparative example in FIG. 5. As a result, the contactless communication apparatus 10 according to the first embodiment can satisfy the criteria of the radio standards.

### Second Embodiment

Next, a contactless communication apparatus 20 according to a second embodiment of the present technology is described. Note that, in and after the second embodiment, a description of a structural element having a function and a configuration that are similar to those in the first embodiment described above are omitted or simplified.

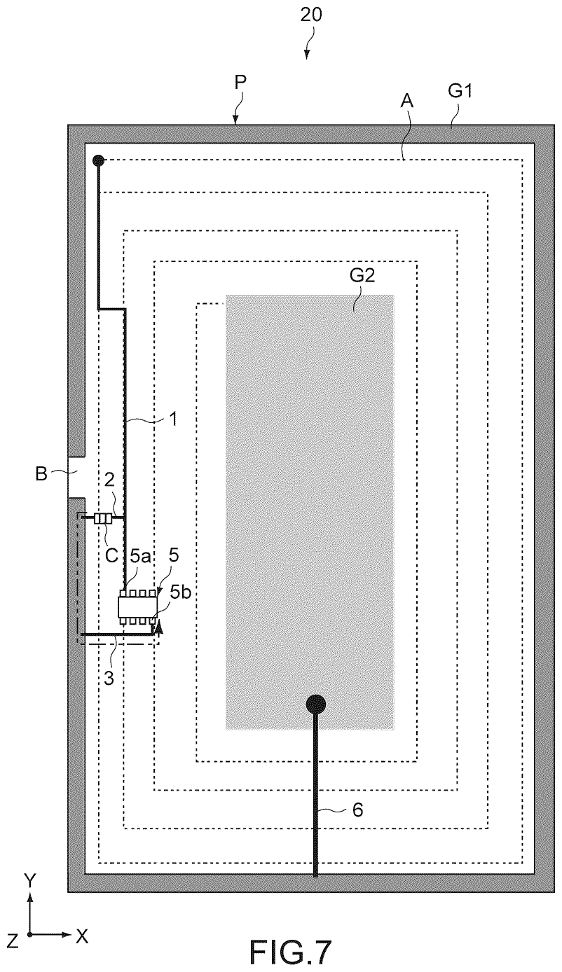

FIG. 7 is a plan view of the contactless communication apparatus 20 according to the second embodiment of the present technology, as viewed from a front surface of the contactless communication apparatus 20. Note that, in FIG. 7, each component arranged on a back surface of the contactless communication apparatus 20 is also shown transparently.

Note that the description of the second embodiment is given focused on a point different from that in the first embodiment described above.

Here, in the first embodiment described above, the second wiring portion 2 connects the first wiring portion 1 and the second ground pattern G2. On the other hand, in the second embodiment, the second wiring portion 2 connects the first wiring portion 1 and the first ground pattern G1 (one of the first ground pattern G1 and the second ground pattern G2 that is connected to the ground terminal 5b of the IC chip 5 through the third wiring portion 3). Specifically, one of ends of the second wiring portion 2 is connected to a middle portion of the first wiring portion 1, and another of the ends is connected to the first ground pattern G1.

Further, in the first embodiment described above, the third wiring portion 3 connects the ground terminal 5b of the IC chip 5 and the second ground pattern G2. On the other hand, in the second embodiment, the third wiring portion 3 connects the ground terminal 5b of the IC chip 5 and the first ground pattern G1. Specifically, one of the ends of the third wiring portion 3 is connected to the ground terminal 5b of the IC chip 5, and another of the ends is connected to the first ground pattern G1.

In the second embodiment, the first ground pattern G1 includes a break portion B obtained by breaking a portion of the first ground pattern G1. In other words, the second embodiment is different from the first embodiment in that the first ground pattern G1 does not extend all around the outer peripheral edge of the board P.

The break portion B of the first ground pattern G1 is provided to a position corresponding to a connection point at which the second wiring portion 2 and the first ground pattern G1 are connected to each other. Correspondingly, the other of the ends of the second wiring portion 2 is connected to a portion corresponding to an end of the first ground pattern G1 that is formed due to the break portion B.

A return path in the second embodiment is a path that passes through a portion of the first wiring portion 1 (from a point of connection with the IC chip 5 to a point of connection with the second wiring portion 2), the second wiring portion 2, a portion within the first ground pattern G1 (refer to a dash-dot-dot line), and the third wiring portion 3.

FIG. 7 illustrates a region downstream of the capacitor C in the return path using the dash-dot-dot line. An excessive high-frequency component is generated in the region situated downstream of the capacitor C and indicated by the dash-dot-dot line. This may be a cause of unnecessary radiation.

However, in the second embodiment, the area of a portion surrounded by the return path typically accounts for, for example, 25% or less, 20% or less, 15% or less, 10% or less, 5% or less, 4% or less, or 3% or less of the area of the front surface (or the back surface) of the board P (or the area of a portion surrounded by the first ground pattern G1), as in the case of the first embodiment.

This results in making the return path shorter and thus in being able to reduce an excessive high-frequency component in the second embodiment, as in the case of the first embodiment. This makes it possible to reduce unnecessary radiation. As a result, the criteria of the radio standards can be satisfied.

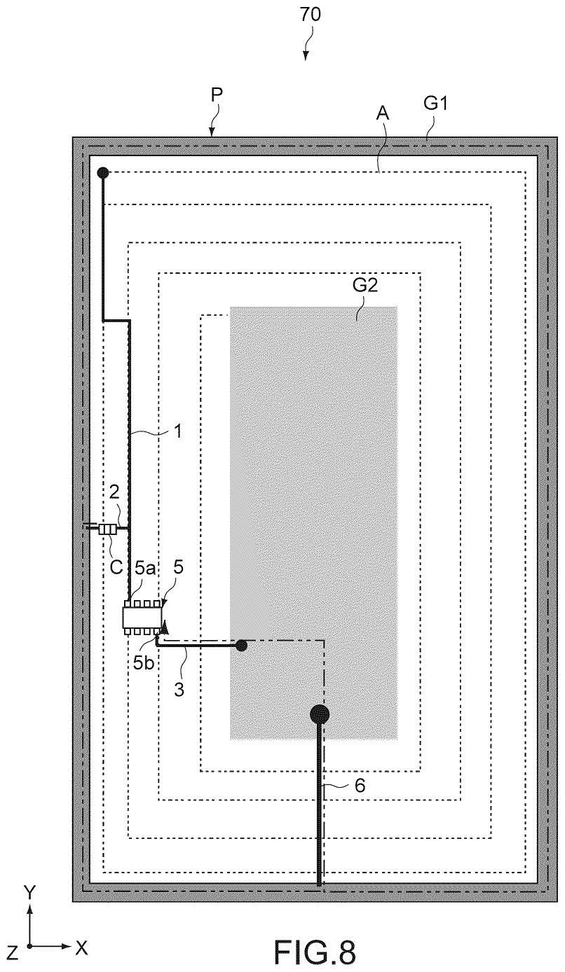

FIG. 8 illustrates a contactless communication apparatus 70 according to a second comparative example. The contactless communication apparatus 70 according to the second comparative example is different from the contactless communication apparatus 20 according to the second embodiment in that the first ground pattern G1 is not provided with the break portion B. Further, the second comparative example is different from the second embodiment in that the third wiring portion 3 connects the ground terminal 5b of the IC chip 5 and the first ground pattern G1. In regard to the other points, the second comparative example is basically similar to the second embodiment.

In the second comparative example, the first ground pattern G1 is not provided with the break portion B. Thus, return paths are long. In the second comparative example, there are two return paths that are a first return path and a second return path.

The first return path is a path that passes through a portion of the first wiring portion 1 (from a point of connection with the IC chip 5 to a point of connection with the second wiring portion 2), the second wiring portion 2, a portion of the first ground pattern G1 (a path passing clockwise from the point of connection with the second wiring portion 2 to a point of connection with the ground connecting wiring portion 6), the ground connecting wiring portion 6, a portion within the second ground pattern G2 (refer to a dash-dot-dot line), and the third wiring portion 3.

Further, the second return path is a path that passes through the portion of the first wiring portion 1 (from the point of connection with the IC chip 5 to the point of connection with the second wiring portion 2), the second wiring portion 2, another portion of the first ground pattern G1 (a path passing counterclockwise from the point of connection with the second wiring portion 2 to the point of connection with the ground connecting wiring portion 6), the ground connecting wiring portion 6, the portion within the second ground pattern G2 (refer to the dash-dot-dot line), and the third wiring portion 3.

FIG. 8 illustrates a region downstream of the capacitor C in the first and second return paths using the dash-dot-dot line. An excessive high-frequency component is generated in the region situated downstream of the capacitor C and indicated by the dash-dot-dot line. This may be a cause of unnecessary radiation. This results in not satisfying the requirement of the radio standards.

In the second comparative example, the area of a portion surrounded by the first return path accounts for about 70% of the area of the front surface of the board P. Further, the area of a portion surrounded by the second return path accounts for about 30% of the area of the front surface of the board P. Thus, a total of the area of the portion surrounded by the first return path and the area of the portion surrounded by the second return path accounts for about 100% of the area of the front surface of the board P.

On the other hand, in the second embodiment, the area of the portion surrounded by the return path accounts for, for example, 25% or less, 20% or less, 15% or less, 10% or less, 5% or less, 4% or less, or 3% or less of the area of the front surface (or the back surface) of the board P. This results in making the return path shorter and thus in being able to reduce an excessive high-frequency component. This makes it possible to reduce unnecessary radiation.

### Third Embodiment

Next, a contactless communication apparatus 30 according to a third embodiment of the present technology is described.

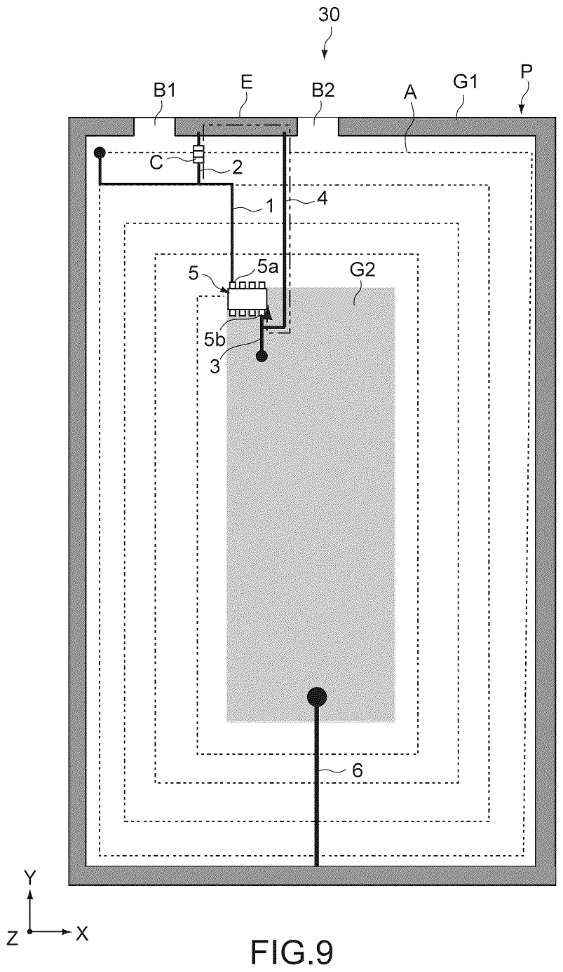

FIG. 9 is a plan view of the contactless communication apparatus 30 according to the third embodiment of the present technology, as viewed from a front surface of the contactless communication apparatus 30. Note that, in FIG. 9, each component arranged on a back surface of the contactless communication apparatus 30 is also shown transparently.

The description of the third embodiment is given focused on a point different from that in the first embodiment (not in the second embodiment).

In the first embodiment described above, the second wiring portion 2 connects the first wiring portion 1 and the second ground pattern G2. On the other hand, in the third embodiment, the second wiring portion 2 connects the first wiring portion 1 and the first ground pattern G1 (one of the first ground pattern G1 and the second ground pattern G2 that is not connected to the ground terminal 5b of the IC chip 5 through the third wiring portion 3) (as in the case of the second embodiment). Specifically, one of ends of the second wiring portion 2 is connected to the first wiring portion 1, and another of the ends is connected to the first ground pattern G1.

Further, the third embodiment is different from the first embodiment (and the second embodiment) in that a fourth wiring portion 4 is added. The fourth wiring portion 4 connects the first ground pattern G1 and the third wiring portion 3. Specifically, one of ends of the fourth wiring portion 4 is connected to the first ground pattern G1, and another of the ends is connected to a middle portion of the third wiring portion 3.

Furthermore, the third embodiment is different from the first embodiment in that the first ground pattern G1 is provided with two break portions B1 and B2. In other words, the first ground pattern G1 includes a first break portion B1 obtained by breaking a portion of the first ground pattern G1, and a second break portion B2 obtained by breaking another portion of the first ground pattern G1. Thus, the third embodiment is different from the first embodiment in that the first ground pattern G1 does not extend all around the outer peripheral edge of the board P (as in the case of the second embodiment).

The first break portion B1 of the first ground pattern G1 is provided to a position corresponding to a connection point at which the second wiring portion 2 and the first ground pattern G1 are connected to each other. The second break portion B2 of the first ground pattern G1 is provided to a position corresponding to a connection point at which the fourth wiring portion 4 and the first ground pattern G1 are connected to each other.

In the third embodiment, a separated region E of the first ground pattern G1 is formed of a region situated between the first break portion B1 and the second break portion B2 in the first ground pattern G1. The separated region E is separated from a primary portion of the first ground pattern G1, but is connected to the second ground pattern G2 through the fourth wiring portion 4 and a portion of the third wiring portion 3. Thus, the separated region E is connected to a ground potential.

The second wiring portion 2 connects the first wiring portion and the separated region E of the first ground pattern. Specifically, one of ends of the second wiring portion 2 is connected to a middle portion of the first wiring portion 1, and another of the ends is connected to a portion corresponding to one of ends of the separated region E of the first ground pattern G1.

Further, the fourth wiring portion 4 connects the separated region E of the first ground pattern G1 and the third wiring portion 3. Specifically, the one of the ends of the fourth wiring portion 4 is connected to a portion corresponding to another of the ends of the separated region E of the first ground pattern G1, and the other of the ends of the fourth wiring portion 4 is connected to the middle portion of the third wiring portion 3.

A return path in the third embodiment is a path that passes through a portion of the first wiring portion 1 (from a point of connection with the IC chip 5 to a point of connection with the second wiring portion 2), the second wiring portion 2, the separated region E of the first ground pattern G1 (refer to a dash-dot-dot line), and the fourth wiring portion 4, and a portion of the third wiring portion 3 (from a point of connection with the fourth wiring portion 4 to the point of connection with the IC chip 5).

FIG. 9 illustrates a region downstream of the capacitor C in the return path using the dash-dot-dot line. An excessive high-frequency component is generated in the region situated downstream of the capacitor C and indicated by the dash-dot-dot line. This may be a cause of unnecessary radiation.

Here, the contactless communication apparatus 60 according to the first comparative example in FIG. 4 is referred to, in order to describe effects of the third embodiment. Note that, if the first and second break portions B1 and B2 of the first ground pattern G1 and the fourth wiring portion 4 are omitted from the contactless communication apparatus 30 according to the third embodiment, the contactless communication apparatus 30 according to the third embodiment has a configuration similar to the configuration of the contactless communication apparatus 60 according to the first comparative example.

As described above, the contactless communication apparatus 10 according to the first comparative example has two return paths that are the first return path and the second return path. Further, the total of the area of the portion surrounded by the first return path and the area of the portion surrounded by the second return path accounts for about 100% of the area of the front surface (or the back surface) of the board P. Thus, in the first comparative example, the return paths are long, and this results in a greater unnecessary radiation.

On the other hand, in the third embodiment, the area of a portion surrounded by the return path typically accounts for, for example, 25% or less, 20% or less, 15% or less, 10% or less, 5% or less, 4% or less, or 3% or less of the area of the front surface (or the back surface) of the board P (or the area of a portion surrounded by the first ground pattern G1), as in the case of the first embodiment (and the second embodiment).

This results in making the return path shorter and thus in being able to reduce an excessive high-frequency component in the third embodiment, as in the case of the first embodiment (and the second embodiment). This makes it possible to reduce unnecessary radiation. As a result, the criteria of the radio standards can be satisfied.

It should be understood by those skilled in the art that various modifications, combinations, sub-combinations and alterations may occur depending on design requirements and other factors insofar as they are within the scope of the appended claims or the equivalents thereof.

What is claimed is:

1. A contactless communication apparatus, comprising:
a board that includes a first surface and a second surface that is situated opposite to the first surface;
a semiconductor component that includes an output terminal and a ground terminal, the semiconductor component being provided on the first surface;
a coil-shaped antenna pattern that includes a start end that is an outer peripheral end, and a termination end that is an inner peripheral end, the antenna pattern being formed on the second surface;
a first ground pattern that is formed along a peripheral edge portion of the first surface;
a second ground pattern that is formed in an air-core portion of the antenna pattern formed on the second surface, the second ground pattern being connected to the first ground pattern;
a first wiring portion that connects the output terminal and the start end;
a second wiring portion that includes a capacitor, the second wiring portion connecting the first wiring portion and the first or second ground pattern;
a third wiring portion that connects the first or second ground pattern and the ground terminal; and
a return path that passes through the first wiring portion, the second wiring portion, the first or second ground pattern, and the third wiring portion, wherein
the area of a portion surrounded by the path accounts for 25% or less of the area of the first surface.

2. The contactless communication apparatus according to claim 1, wherein
the second wiring portion connects one of the first and second ground patterns and the first wiring portion, the one of the first and second ground patterns being connected to the ground terminal through the third wiring portion.

3. The contactless communication apparatus according to claim 1, wherein
the second wiring portion connects one of the first and second ground patterns and the first wiring portion, the one of the first and second ground patterns not being connected to the ground terminal through the third wiring portion.

4. The contactless communication apparatus according to claim 2, wherein
the second wiring portion connects the first wiring portion and the second ground pattern, and
the third wiring portion connects the second ground pattern and the ground terminal.

5. The contactless communication apparatus according to claim 2, wherein
the second wiring portion connects the first wiring portion and the first ground pattern, and
the third wiring portion connects the first ground pattern and the ground terminal.

6. The contactless communication apparatus according to claim 5, wherein
the first ground pattern includes a break portion obtained by breaking a portion of the first ground pattern, and
the second wiring portion is connected to a portion corresponding to an end of the first ground pattern that is formed due to the break portion.

7. The contactless communication apparatus according to claim 3, wherein
the second wiring portion connects the first wiring portion and the first ground pattern,
the third wiring portion connects the second ground pattern and the ground terminal, and
the contactless communication apparatus further comprises a fourth wiring portion that connects the first ground pattern and the third wiring portion.

8. The contactless communication apparatus according to claim 7, wherein
the first ground pattern includes
a first break portion obtained by breaking a portion of the first ground pattern,
a second break portion obtained by breaking another portion of the first ground pattern, and
a separated region that is formed between the first break portion and the second break portion.

9. The contactless communication apparatus according to claim 8, wherein
the second wiring portion connects the first wiring portion and the separated region of the first ground pattern, and
the fourth wiring portion connects the separated region of the first ground pattern and the third wiring portion.

10. The contactless communication apparatus according to claim 1, wherein
the area of the portion surrounded by the return path accounts for 20% or less of the area of the first surface.

11. The contactless communication apparatus according to claim 10, wherein
the area of the portion surrounded by the return path accounts for 15% or less of the area of the first surface.

12. The contactless communication apparatus according to claim 11, wherein
the area of the portion surrounded by the return path accounts for 10% or less of the area of the first surface.

13. The contactless communication apparatus according to claim 12, wherein
the area of the portion surrounded by the return path accounts for 5% or less of the area of the first surface.
